(19) United States
(12) Patent Application Publication
(10) Pub. No.: US 2016/0034126 A1
(43) Pub. Date: Feb. 4, 2016

(54) VISUAL CUES FOR SCROLLING

(71) Applicant: Viktor Kaptelinin, Hornefors (SE)

(72) Inventor: Viktor Kaptelinin, Hornefors (SE)

(21) Appl. No.: 14/812,123

(22) Filed: Jul. 29, 2015

Related U.S. Application Data
(60) Provisional application No. 62/030,437, filed on Jul. 29, 2014.

(51) Int. Cl. G06F 3/0485; G06F 3/0481; G06F 3/0488

(52) U.S. Cl. CPC G06F 3/0485; G06F 3/04855; G06F 3/04886; G06F 3/0481; G06F 3/04883

(57) ABSTRACT

The invention discloses a method and apparatus for helping the user of computer devices, such as desktop computers, laptop computers, tablet computers, smartphones, and augmented reality devices, to view information displayed during and after scrolling, when scrolling is performed with variable increment scrolling input devices, such as scroll wheels or touch-sensing devices. According to an embodiment of the invention, the area of the displayed document, which corresponds to the location of the screen pointer immediately before scrolling or the point of the initial user contact with a touchscreen, is highlighted with visual cues during and shortly after scrolling to support the continuity of user's attention.

### CROSS-REFERENCE TO RELATED APPLICATIONS

Provisional Patent Application of Viktor Kaptelinin, Ser. Nr. 62/030,437 filed Jul. 29, 2014.

### FEDERALLY SPONSORED RESEARCH

Not Applicable

### BACKGROUND OF THE INVENTION

The invention relates to user interfaces of computing devices, such as desktop computers, laptop computers, tablet computers, smartphones, electronic bookreaders, and so forth.

Computing devices having screens typically display various visual contents in windows, that is, dedicated viewing areas of a screen. In the context of this invention the term “window” is understood in a broad sense, as a content viewing area of any displays, including displays of tablet computers, smartphones, bookreaders, and embedded systems.

Only a portion of a window-related content, such as a document, may be displayed in a window, and the user may need to scroll the window to see other portions of the content. Many modern computing devices support variable increment scrolling, for instance, scrolling by using a scroll wheel of a computer mouse or by performing multi-touch gestures (e.g., panning or flicking) on touch-sensing input devices, such as touchpads or touchscreens. When using a scroll wheel, touch pad, or touchscreen, the user can decide on a moment-to-moment basis how much scrolling is to be achieved by a certain scroll action.

Three types of variable increment scrolling, known in prior art, are shown in FIGS. 1-3. FIG. 1a schematically depicts window 100, which is displaying portion 103 of its content, before the user scrolls window 100 by rolling up a scroll wheel 150, said scroll wheel being a part of mouse 160. FIG. 1b depicts window 100, which is displaying portion 105 of its content, after the user scrolls window 100 by rolling a scroll wheel 150 up. Portion 105 contains two lines 107, which are are not contained in portion 103. FIGS. 1a and 1b also show screen pointer 120.

Scrolling a window changes the location of objects displayed in the window (thereafter, “display location”). For instance, the scrolling action illustrated by FIG. 1a and FIG. 1b changes the display location of letter sequence 125 (“tation”) so that said sequence is displayed higher in the window. Some objects, such as the first two lines of portion 110 (FIG. 1a), may become not visible after scrolling.

Display locations of an object shown in a window can be described, for instance, by window coordinates of the point generally corresponding to the geometrical center of the area displaying the object. For instance, the change of the display location of letter sequence 125, shown in FIG. 1a and FIG. 1b, can be described as a change of the window coordinates of the point generally corresponding to the geometrical center of the area displaying sequence 125 from “x, y1” to “x, y2”. It should be noted that the scroll action shown in FIG. 1a and FIG. 1b only involves vertical scrolling, so that only the “y” window coordinate is changing. If a scroll action involves has both vertical and horizontal components, as in case of oblique scrolling, both “x” and “y” coordinates of screen objects will change.

FIG. 2 depicts a scroll action similar to the one depicted in FIG. 1, with a difference that the scroll action depicted in FIG. 2 is achieved by performing a panning gesture when using a touch pad. The user moves two fingers while maintaining contact with a touchpad, so the displayed content moves in the respective direction as long as the contact is not interrupted. FIG. 3 depicts scrolling by flicking when using a touch screen: the content of a window continues to move after the contact between user's finger 300 and the touch-sensing device is terminated, as if the scrolled image had physical inertia. The movement eventually slows down and stops; the speed of scrolling and the distance over which the content moves before it stops depend on the speed of the movement of users' finger.

By employing the aforementioned devices users can perform variable-increment scrolling actions more directly, without using a separate graphical user interface (GUI) widget, such as a scroll bar. However, there is a problem with variable increment direct scrolling, especially when a separate touch-sensing device is used or the flicking gesture is executed. Changing display locations of objects displayed in a window, especially if the change is fast, may make it difficult for the user to maintain the continuity of attention to the content displayed in the window. As a result, users may “loose their place” on a display: users' attention can be disrupted, orientation lost, and the user may need to scan the new, post-scroll image, to ensure the continuity of attention after scrolling.

Prior art teaches visual cues that can be used to mitigate or eliminate the problem of “loosing one's place” on a page after scrolling, for instance, by visually separating old and new content. However, these teachings do not provide sufficient support for dealing with attention interruptions caused by variable increment scrolling.

### SUMMARY OF THE INVENTION

The invention teaches visual cues that generally continuously highlight a “reference document area”, which is defined as an area of the displayed document, which is displayed generally at the “initial display location”. “Initial display location”, in turn, is defined as either: (a) the screen location of the initial contact of the user with a touchscreen when performing a scroll action, if the scroll action is performed through a touchscreen gesture, or (b) the screen location of the screen pointer immediately before a scrolling, if a separate device different from the screen, such as scroll wheel or touchpad, is used. When a window scrolls, the reference document area is displayed in other screen areas than the selected location of the screen. For instance, FIG. 1 shows how the reference document area corresponding to letter sequence 125, which sequence is displayed generally at the initial display location (that is, screen location of pointer 120 immediately before the scrolling, FIG. 1a) changes its display location and is displayed after scrolling higher in window 110 (FIG. 1b).

The present invention is based on the assumption that visual cues generally continuously highlighting a reference document area during scrolling will allow the user to visually perceive, assess, and, if necessary, adjust the scrolling distance and thus more efficiently maintain the continuity of attention when viewing the content presented during or after scrolling.

In some embodiments of the invention a method is disclosed for assisting a user of an electronic device, said device having at least a processor, a memory storage, which can be integrated with said processor, a variable increment scrolling input device, such as a scroll wheel or a touch-sensing device, and a display, which can be integrated with said input device, for instance, in the form of a touch-sensitive display, said display having an at least a window displaying a portion of at least a document; in viewing information displayed during or after scrolling of said display window to a new portion of said document, the method comprising the method steps of:

providing machine-comprised means for the user to scroll said display window in a certain (e.g., vertical, horizontal, or oblique) dimension by performing a scrolling user action selected from a group comprising at least: (a) rolling a scroll wheel of a computer mouse, (b) performing a single-touch or multi-touch gesture, such as scrolling, panning, tapping, or flicking on a touch-sensing device, such as touch pad, or (c) performing a single-touch or multi-touch gesture, such as scrolling, panning, tapping, or flicking on a touch-sensitive display.

detecting a first scrolling user action; and

if the first scrolling user action is detected then

detecting an initial display location, said initial display location being either
(a) a location of a screen pointer at a moment when the first scrolling user action is detected, if a separate input device, such as scroll wheel or touch-sensing device, is used; or
   (b) a screen location of user's contact with the display at a moment when the first scrolling user action is detected, if a touch-sensitive display, such as touch screen, is used; and

create, through machine-comprised means, a computer memory description of an area of said document, which is displayed at generally said initial display location (thereafter, “reference document area”); and

scrolling said display window to a new portion of said document, wherein generally continuously providing a first visual cue for highlighting said reference document area as long as said reference document area is visible in said display window, and

disabling said first visual cue after a first predetermined amount of time.

In other embodiments the above method further comprises the steps of
detecting whether a second scrolling action is initiated by the user after less than a second predetermined amount of time after the first scrolling action; and
if a second scrolling user action is detected after less than a second predetermined amount of time after the first scrolling action, then scrolling the display window to a new portion of said document, wherein generally continuously providing a first visual cue for highlighting the reference document area as long as said reference document area is visible in said display window, and
disabling said first visual cue after a third predetermined amount of time.

In some embodiments a method is disclosed, further comprising the optional step of generally continuously providing a second visual cue for highlighting a distance between said reference document area and said initial display location.

In yet another embodiment a method is disclosed, wherein the first visual cue is disabled by gradually fading away.

In still another embodiment a method is disclosed, wherein the presence or absence, size, shape, color, and transparency of the first visual cue can be defined or selected by the user.

In some embodiments an apparatus is disclosed, comprising at least

a processor; and

a memory storage, which can be integrated with said processor; and

a variable increment scrolling input device, such as a scroll wheel or a touch-sensing device; and

a display, which can be integrated with said input device, for instance, in the form of a touch-sensitive display, said display including at least a window displaying a portion of at least a document; and

machine-comprised means for the user to scroll said display window in an at least vertical dimension by performing a scrolling user action selected from a group comprising at least: (a) rolling a scroll wheel of a computer mouse and (b) performing a single-touch or multi-touch gesture, such as scrolling, panning, tapping, or flicking; and

means for detecting a third scrolling user action; and

means for detecting an initial display location, said initial display location being either
(a) a location of a screen pointer at a moment when the third scrolling user action is detected, if a separate input device, such as scroll wheel or touch-sensing device, is used; or
(b) a screen location of user's contact with the display at a moment when the third scrolling user action is detected, if a touch-sensitive display, such as touch screen, is used; and

means for detecting a reference document area as an area of said document displayed at generally said initial display location at the moment when the third scrolling user action is initiated; and

means for scrolling said display to a new portion of said document, wherein generally continuously providing a third visual cue for highlighting the reference document area as long as said reference document area is visible on said display, and

means for disabling said third visual cue after a fourth predetermined amount of time.

In some embodiments the above apparatus further comprises

means for detecting whether a fourth scrolling action is initiated by the user in less than a fifth predetermined amount of time after the third scrolling action; and

means for scrolling the display to a new portion of said document, wherein generally continuously providing a third visual cue for highlighting the reference document area as long as said reference document area is visible on said display, if a fourth scrolling action is initiated by the user in less than a fifth predetermined amount of time after the third scrolling action; and

means for disabling said third visual cue after a sixth predetermined amount of time.

In other embodiments an apparatus is disclosed, further comprising means for defining or selecting the presence or absence, size, shape, color, and transparency of the third visual cue through a user-action.

In some embodiments the above apparatus further comprises
means for detecting whether a forth scrolling action is initiated by the user in less than a fifth predetermined amount of time after the third scrolling action; and
means for scrolling the display to a new portion of said document, wherein generally continuously providing a fifth visual cue for highlighting the reference document area as long as said contact document area is visible on said display, and
means for disabling said fifth visual cue after a sixth predetermined amount of time.

### BRIEF DESCRIPTION OF THE DRAWINGS

FIGS. 1a-1b illustrate a prior art method of scrolling with a scroll wheel.

FIGS. 2a-2b illustrate a prior art method of scrolling with a touch-sensing device, such as touch pad.

FIGS. 3a-3c illustrate a prior art method of scrolling by performing a flicking gesture on a touch screen.

FIGS. 4a-4c illustrate the input device and GUI display according to some embodiments of the invention.

FIGS. 5a-5b illustrate the input device and GUI display according to some embodiments of the invention.

FIGS. 6a-6c illustrate the input device and GUI display according to some embodiments of the invention.

FIGS. 7a-7c illustrate the input device and GUI display according to some embodiments of the invention.

FIGS. 8a-8d illustrate the input device and GUI display according to some embodiments of the invention.

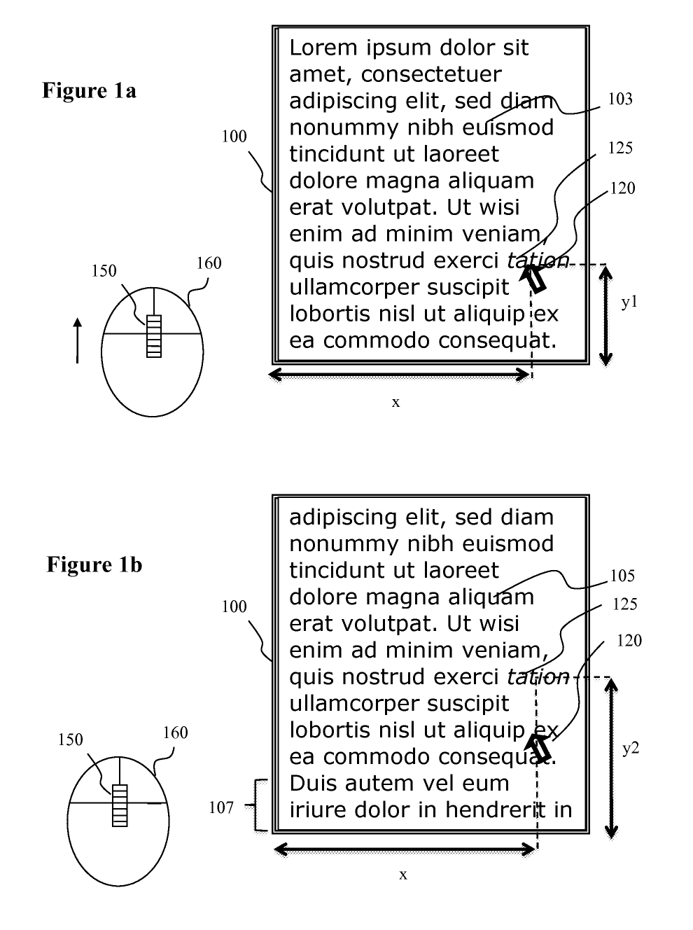

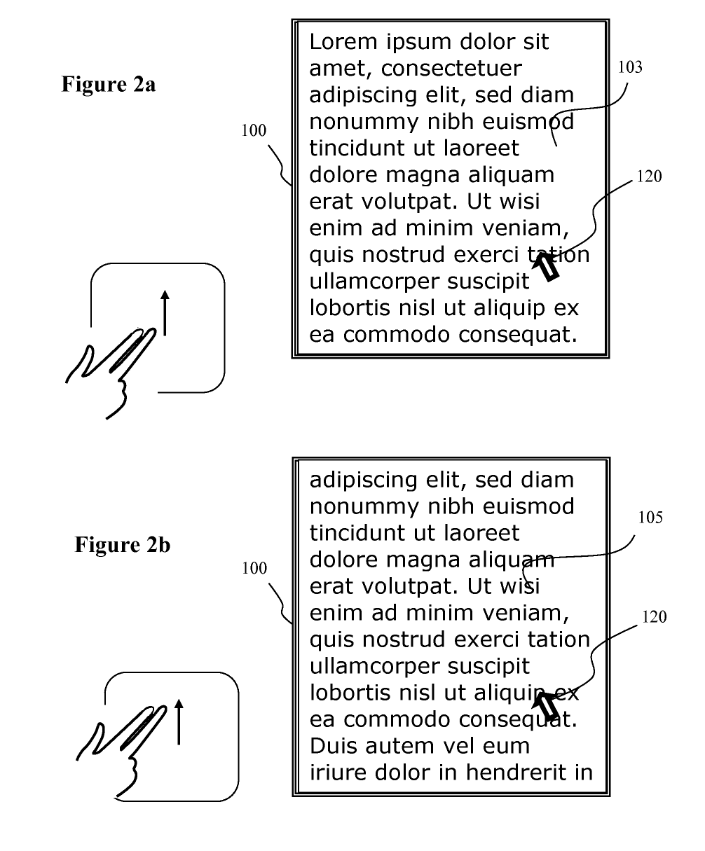

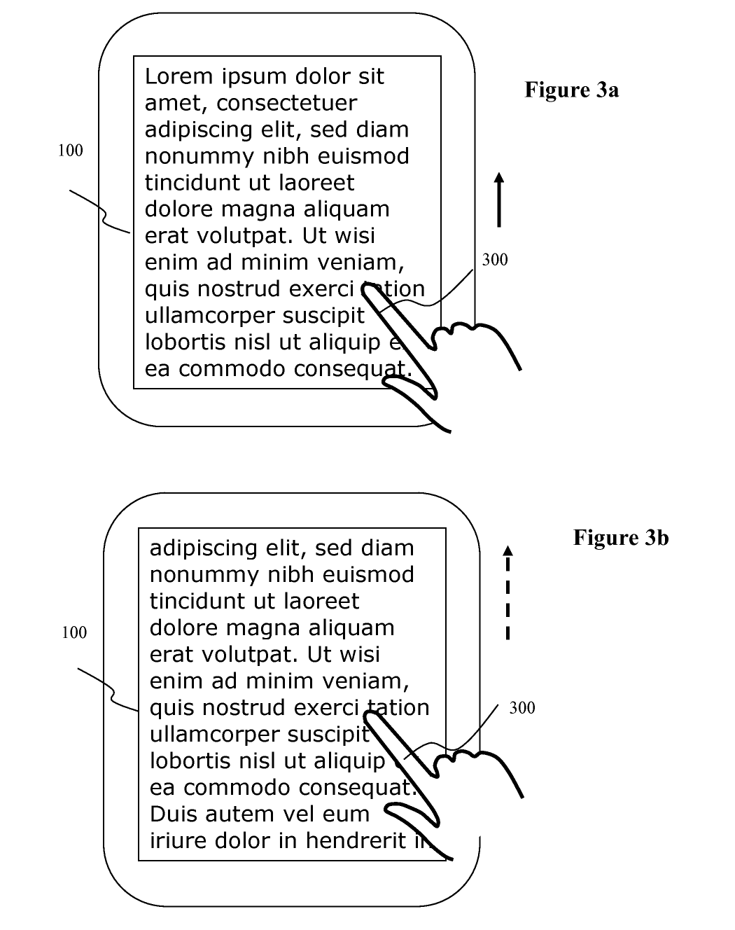

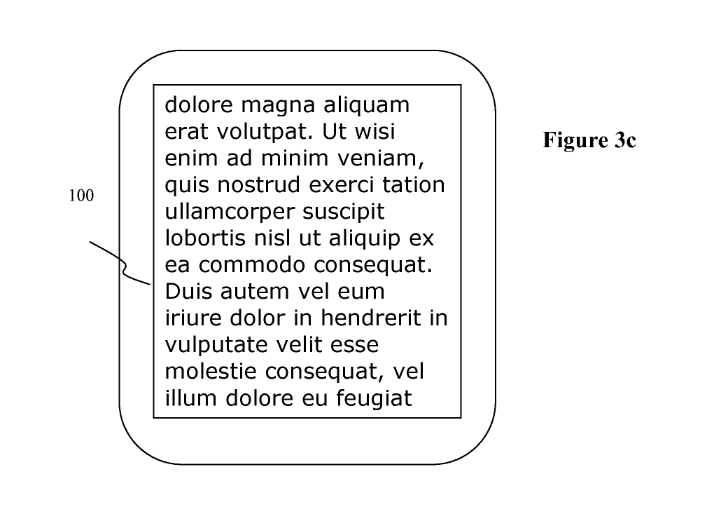

### DETAILED DESCRIPTION OF THE INVENTION

The first embodiment discloses a method and apparatus for scrolling a document by using a separate touch-sensing device, such as touchpad, for panning The user makes an initial contact with the device with two fingers, then moves the contact area, while maintaining a continuing contact with the device, away from the initial contact area, so that the direction and distance of the scrolling are determined by the direction and distance of the movement from the initial contact area to a new contact area. No scrolling takes place when the contact between user's fingers and the touch-sensing device is interrupted.

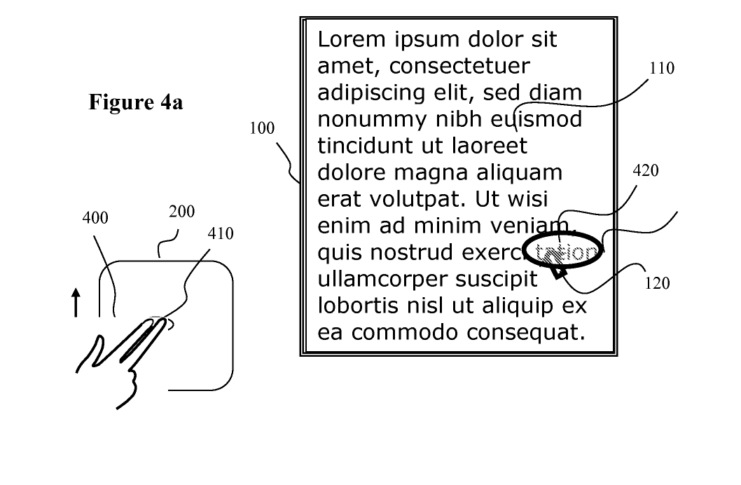

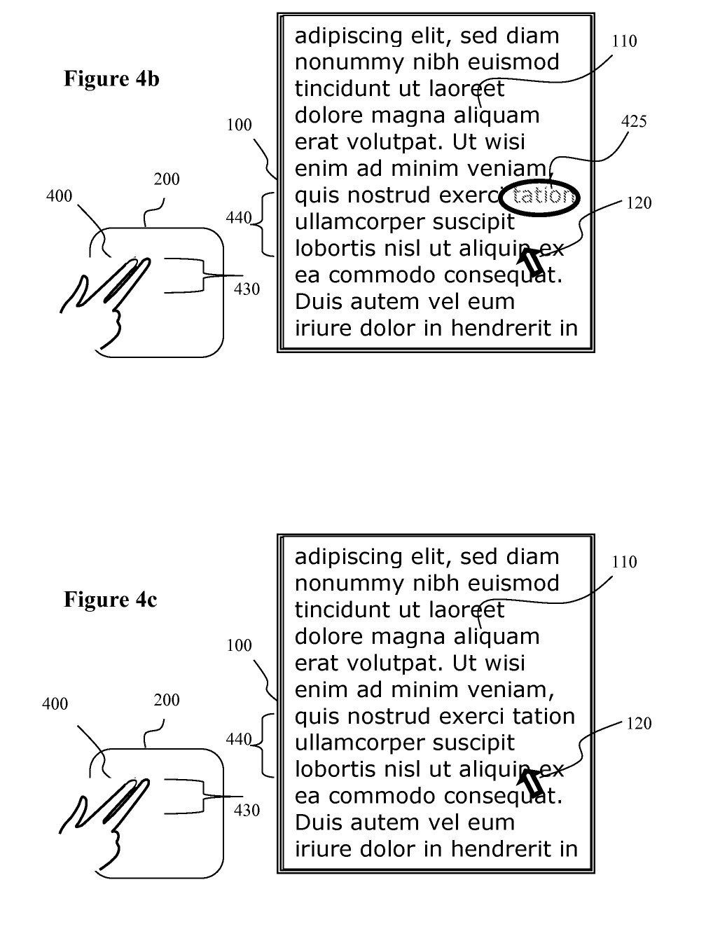

The first embodiment is illustrated by FIG. 4. FIG. 4a shows a window 100 that displays a portion of window-related content 110. User's fingers 400 make initial contact with a touch-sensing device 200 in an area 410 of the device 200. The screen location of a pointer 120 in window 100 immediately before scrolling, that is, initial display location, corresponds to reference document area 420 of content 110 (which area is generally displaying a letter sequence “tation”). Visual cue 425 is displayed in window 100 to highlight reference document area 420. As shown in FIG. 4b, when user's fingers 400 move up for distance 430, content 110 scrolls up for distance 440, and reference document area highlighted by visual cue 425 also moves up for distance 440 (FIG. 4b). Visual cue 425 is disabled after a predetermined amount of time (FIG. 4c).

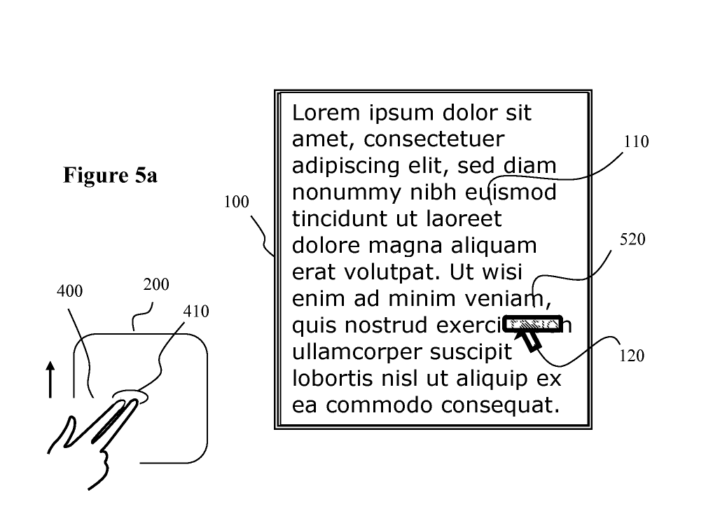

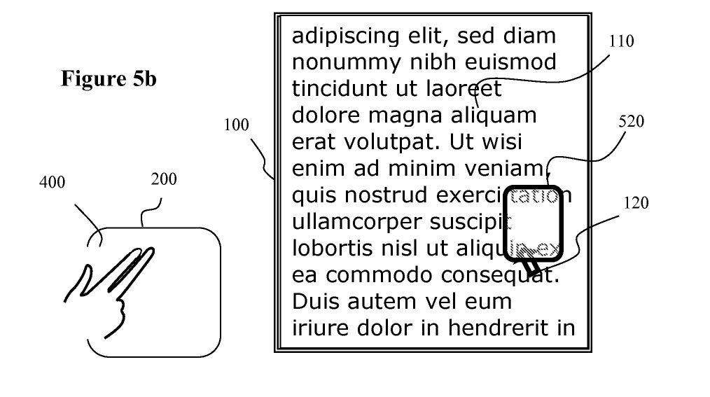

It should be noted that various types of visual cues are covered by the invention, including spots of various size and shape, a highlighted line of text, and other visual cues. For instance, FIG. 5 depicts an elongated semi-transparent screen artefact 520 displayed generally between an initial display location and a current screen location of reference document area during or after scrolling.

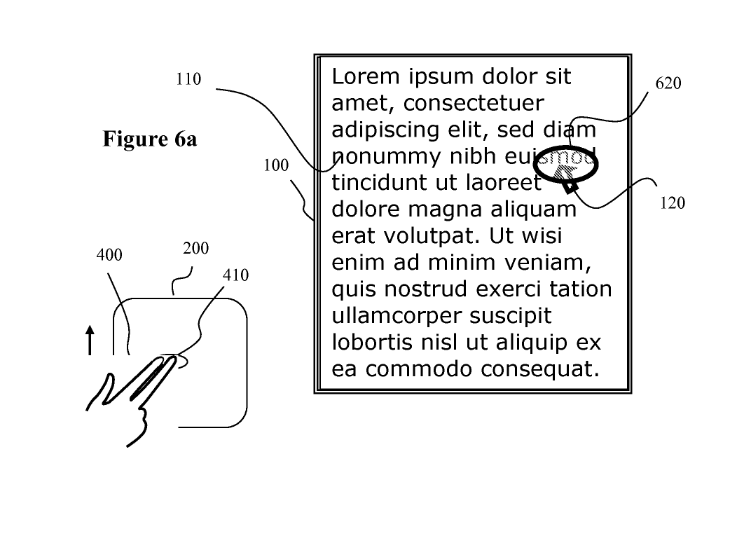

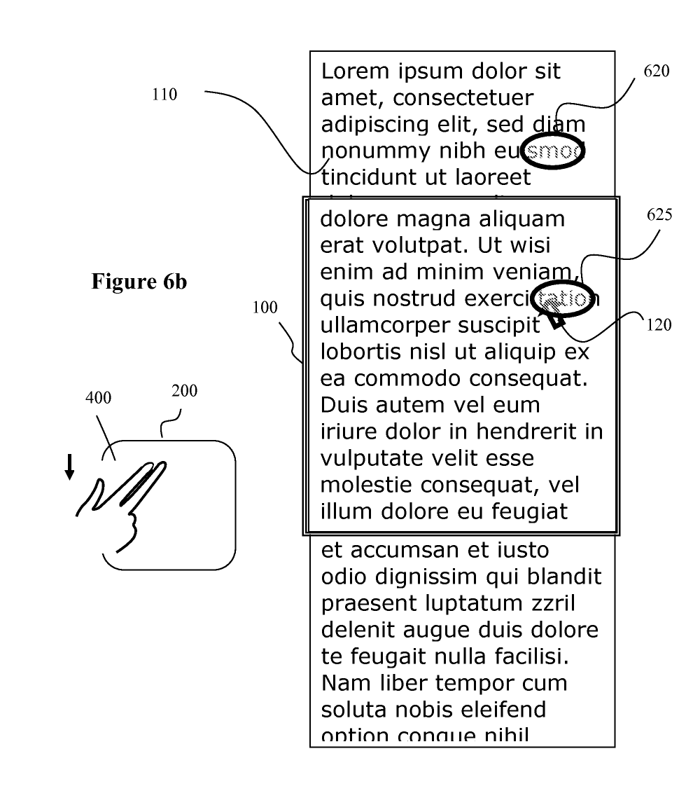

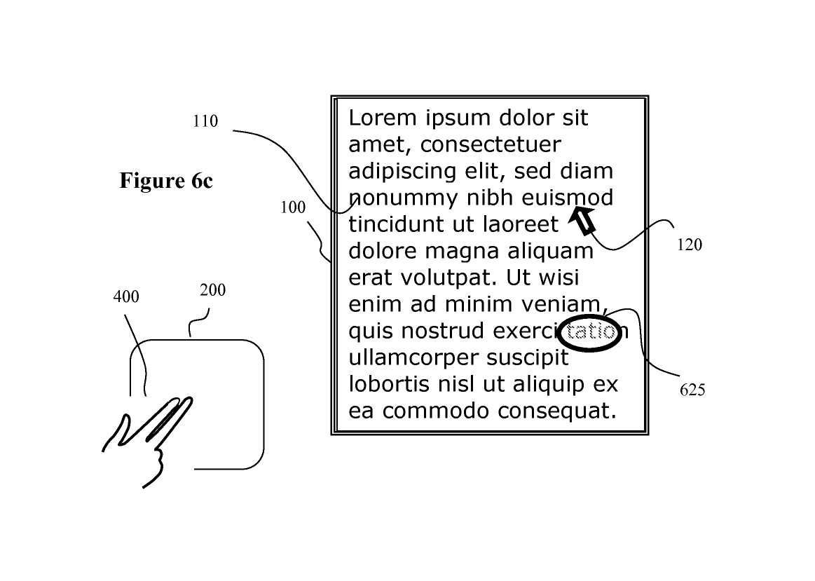

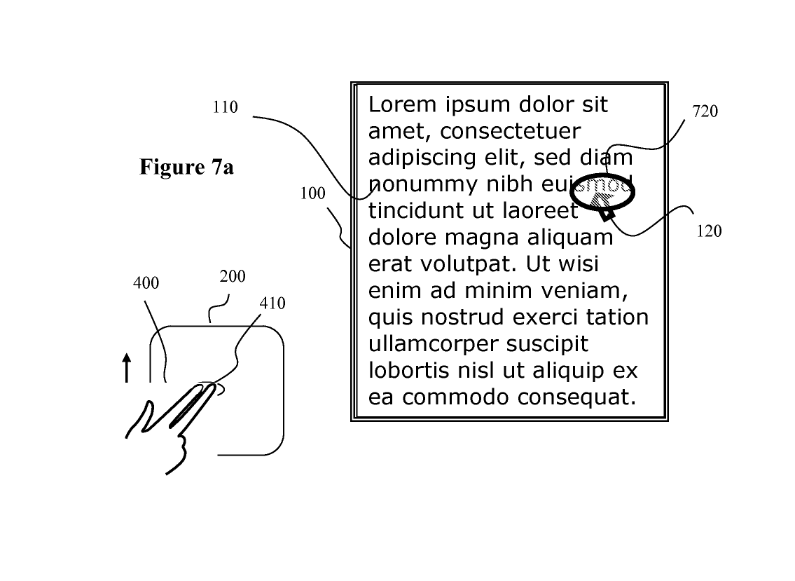

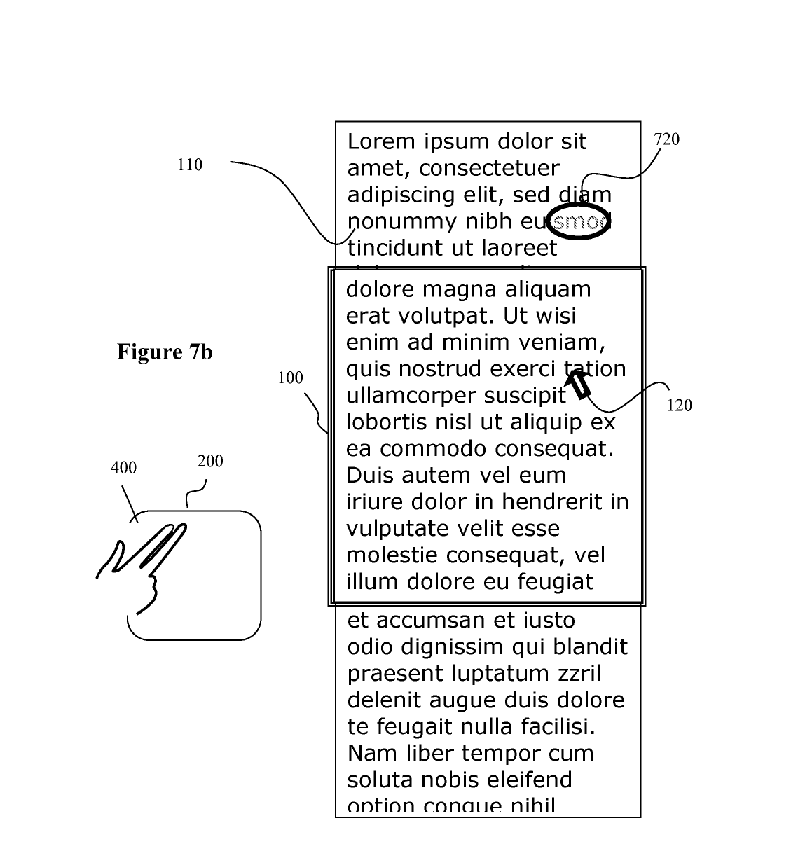

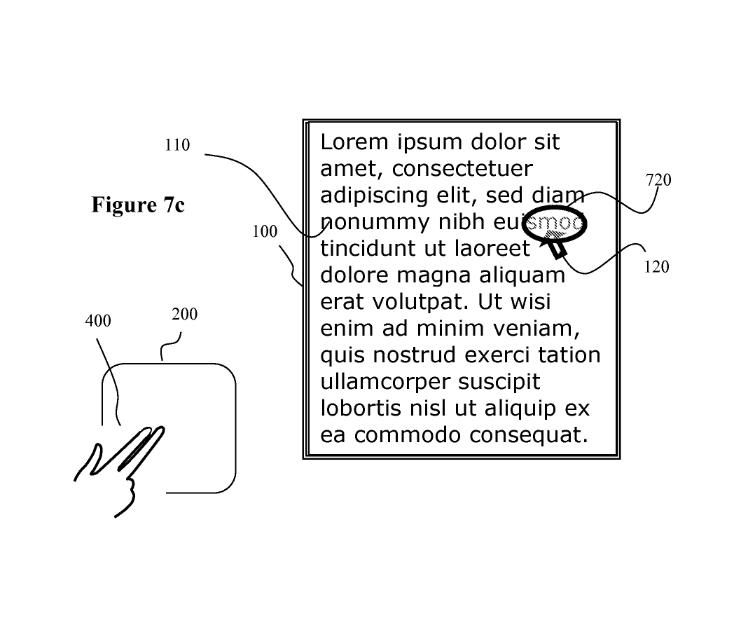

The visual cue disclosed in the present invention is disabled after a predetermined amount of time when the scrolling action is completed. However, if a new scrolling action is initiated before the visual cue is disabled, then the visual cue from the previous scrolling action is used instead of generating a new one. FIG. 6 depicts a sequence of two scrolling actions, first scrolling up and then scrolling down by the same distance, with the second scrolling action taking place after more than a predetermined amount of time after the first action is completed. The first action (FIG. 6a and FIG. 6b) produces a visual cue 620 and moves the cue, along with its corresponding reference document area, outside the display limits, which renders visual cue 420 invisible. The second scrolling action (FIG. 6b and FIG. 6c) produces a new visual cue 625 indicating that a scrolling down is being performed. FIG. 7 depicts a sequence of two scrolling actions, scrolling up and then scrolling down by the same distance, with the second scrolling action taking place after less than a predetermined amount of time after the first action. The first action (FIG. 7a and FIG. 7b) produces a visual cue 720 and moves the cue, along with its corresponding reference document area, outside the display limits, which renders visual cue 720 invisible. The second action (FIG. 6b and FIG. 6c) brings visual cue 720 back to window 100 rather than producing a new visual cue.

An obvious variation of the first embodiment is scrolling to a new content by performing a panning gesture on a touchscreen. In that case users commonly employ a one-finger gesture and the direction and distance of the scrolling are the same as the direction and distance of the movement from the initial contact point to a new contact point. Otherwise the visual cue is used in generally the same manner as described in FIG. 4.

A second embodiment of the invention discloses a method and apparatus for scrolling a document by using a separate touch-sensing device, such as touchpad, to perform scrolling by flicking, that is, making an initial contact with the device, then moving the contact point away from the initial contact point, and then breaking the contact with the touch-sensing device, so that the document continues to scroll for some time, while possibly slowing down, so that the direction and distance of the scrolling are determined by the direction, distance, and speed of the movement away from the initial contact point.

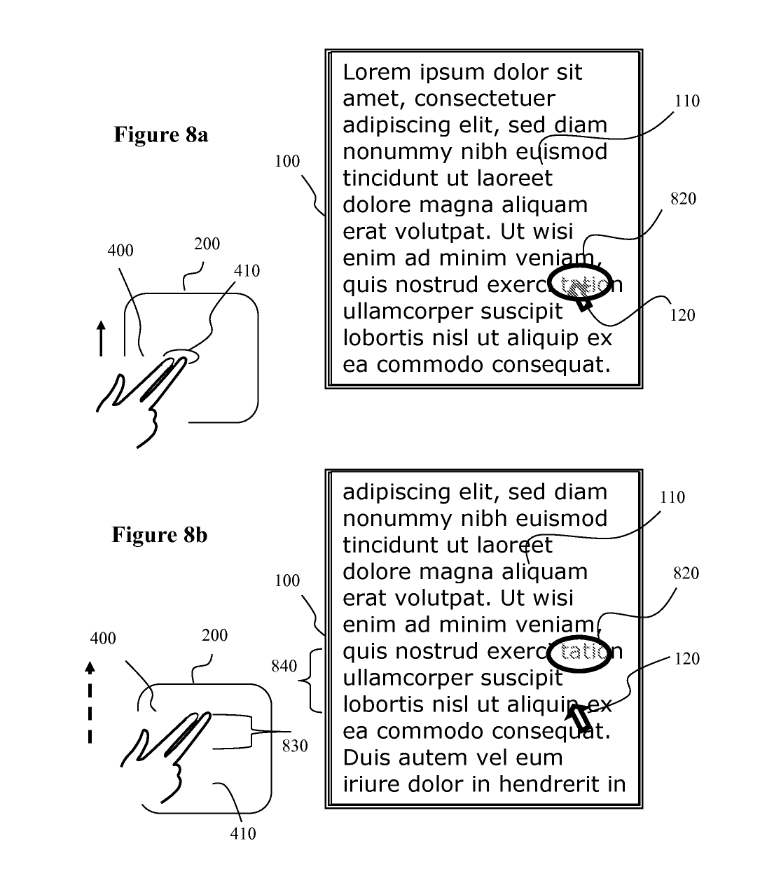

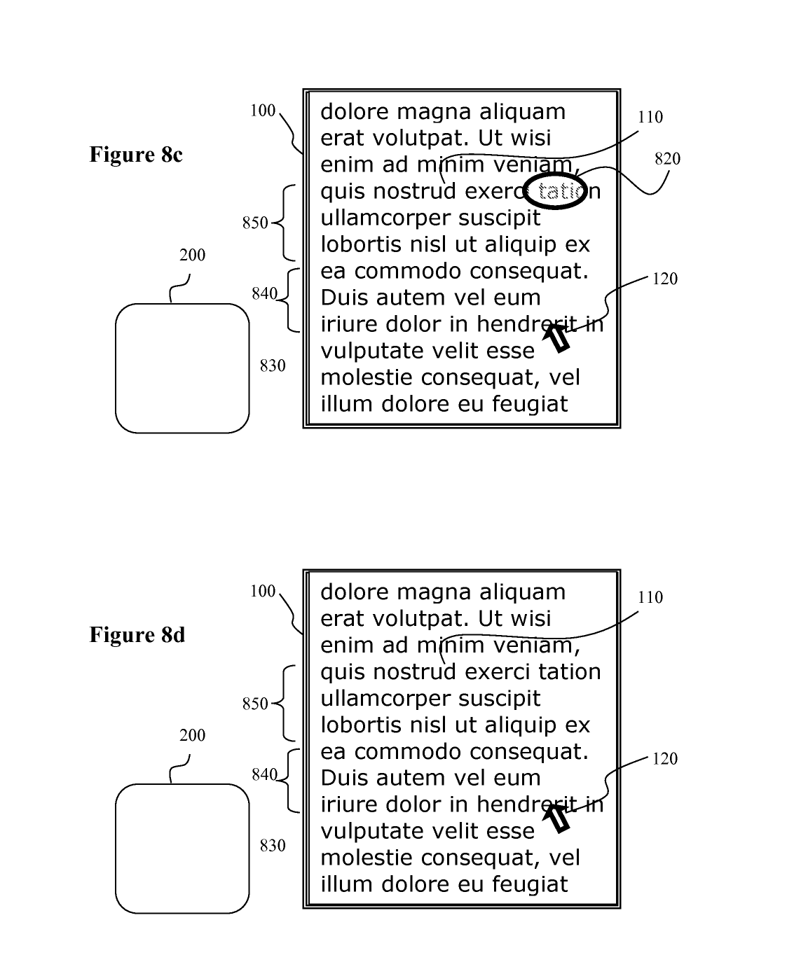

The second embodiment is illustrated by FIG. 8. FIG. 8a shows user's fingers 400 making the initial contact with the touch-sensing device 200 in area 410 of device 200. A visual cue 820 is displayed in window 100 to highlight a reference document area of document 110, generally displayed at the screen location of the pointer 120 immediately before scrolling. When user's fingers 400 move up for distance 830 while maintaining contact with device 200, content 110 scrolls up for distance 840 and visual cue 820 also moves up for distance 440 (FIG. 8b). When user's fingers 400 break contact with device 200, document 110 additionally scrolls up for distance 850 and visual cue 820 also moves up for distance 850 (FIG. 8c). Then after a predetermined amount of time visual cue 820 fades away and disappears (FIG. 8d).

An obvious variation of the second embodiment is scrolling to a new content by performing a flicking gesture on a touch-screen. In that case the direction and distance of the scrolling are determined by the direction, distance, and speed of the movement away from the initial contact point. Otherwise the visual cue is used in generally the same manner as described in FIG. 8.

Another variation of the second embodiment is scrolling to a new content by rolling a scroll wheel or using a similar scroll action controlling input device, which can or cannot be integrated with a computer mouse. In that case the direction and distance of scrolling are determined by the parameters of the user action, such as direction, distance, time, and speed, performed on the scroll wheel or similar device.

According to an embodiment of the invention, the presence or absence, size, shape, color, and transparency of the first visual cue can be defined or selected by the user.

In the context of the present invention the term “document” is understood in a broad sense, as including all kinds of information objects, viewing of which may require scrolling: text, graphics, video, maps, computer folders, computer desktops, augmented reality images, virtual reality images, computer game scenes, and so forth.

The user may select options and preferences, including enabling or disabling the visual cue, time thresholds, types of the visual cue, and a spatial offset between screen pointer location (alternatively, user contact point when using a touchscreen device) and a visual cue. For instance, the user may prefer a visual cue to be displayed on a margin of a document rather than overlaid on the content of a document.

The term “display” is also understood in a broadest sense, as covering all types of displays, including touch screens, augmented reality glasses and helmets, virtual reality glasses and helmets, in-car head up displays, and so forth.

What is claimed is:

1. A method for assisting a user of an electronic device
said device having at least a processor, a memory storage, which can be integrated with said processor, a variable increment scrolling input device, such as a scroll wheel or a touch-sensing device, and a display, which can be integrated with said input device, for instance, in the form of a touch-sensitive display, said display having an at least a window displaying a portion of at least a document;
in viewing information displayed during or after scrolling of said display window to a new portion of said document, the method comprising the method steps of:
providing machine-comprised means for the user to scroll said display window in an at least vertical dimension by performing a scrolling user action selected from a group comprising at least: (a) rolling a scroll wheel, and (b) performing a single-touch or multi-touch gesture, such as scrolling, panning, tapping, or flicking; and
detecting a first scrolling user action; and
if the first scrolling user action is detected then
detecting an initial display location, said initial display location being either
(a) a location of a screen pointer at a moment when the first scrolling user action is detected, if a separate input device, such as scroll wheel or touch-sensing device, is used; or
(b) a screen location of user's contact with the display at a moment when the first scrolling user action is detected, if a touch-sensitive display, such as touch screen, is used; and
create, through machine-comprised means, a computer memory description of an area of said document, which is displayed at generally said initial display location (thereafter, “reference document area”); and
scrolling said display window to a new portion of said document, wherein generally continuously providing a first visual cue for highlighting said reference document area as long as said reference document area is visible in said display window, and
disabling said first visual cue after a first predetermined amount of time.

2. A method of claim 1, further comprising the steps of
detecting whether a second scrolling action is initiated by the user after less than a second predetermined amount of time after the first scrolling action; and
if a second scrolling user action is detected after less than a second predetermined amount of time after the first scrolling action, then scrolling the display window to a new portion of said document, wherein generally continuously providing a first visual cue for highlighting the reference document area as long as said reference document area is visible in said display window, and
disabling said first visual cue after a third predetermined amount of time.

3. A method of claim 2, further comprising the optional step of generally continuously providing a second visual cue for highlighting a distance between said reference document area and said initial display location.

4. A method of claim 1, wherein the first visual cue is disabled by gradually fading away.

5. A method of claim 1, wherein the presence or absence, size, shape, color, and transparency of the first visual cue can be defined or selected by the user.

6. A method of claim 3, wherein the presence or absence, size, shape, color, and transparency of the second visual cue can be defined or selected by the user.

7. An apparatus, comprising at least
a processor; and
a memory storage, which can be integrated with said processor; and
a variable increment scrolling input device, such as a scroll wheel or a touch-sensing device; and
a display, which can be integrated with said input device, for instance, in the form of a touch-sensitive display, said display including at least a window displaying a portion of at least a document; and
machine-comprised means for the user to scroll said display window in an at least vertical dimension by performing a scrolling user action selected from a group comprising at least: (a) rolling a scroll wheel of a computer mouse and (b) performing a single-touch or multi-touch gesture, such as scrolling, panning, tapping, or flicking; and
means for detecting a third scrolling user action; and
means for detecting an initial display location, said initial display location being either
(a) a location of a screen pointer at a moment when the third scrolling user action is detected, if a separate input device, such as scroll wheel or touch-sensing device, is used; or
(b) a screen location of user's contact with the display at a moment when the third scrolling user action is detected, if a touch-sensitive display, such as touch screen, is used; and
means for detecting a reference document area as an area of said document displayed at generally said initial display location at the moment when the third scrolling user action is initiated; and
means for scrolling said display to a new portion of said document, wherein generally continuously providing a third visual cue for highlighting the reference document area as long as said reference document area is visible on said display, and
means for disabling said third visual cue after a fourth predetermined amount of time.

8. An apparatus of claim 7, further comprising
means for detecting whether a fourth scrolling action is initiated by the user in less than a fifth predetermined amount of time after the third scrolling action; and
means for scrolling the display to a new portion of said document, wherein generally continuously providing a third visual cue for highlighting the reference document area as long as said reference document area is visible on said display, if a fourth scrolling action is initiated by the user in less than a fifth predetermined amount of time after the third scrolling action; and
means for disabling said third visual cue after a sixth predetermined amount of time.

9. An apparatus of claim 7, further comprising means for defining or selecting the presence or absence, size, shape, color, and transparency of the third visual cue through a user-action.
